(19) United States
(12) Patent Application Publication
(10) Pub. No.: US 2019/0080017 A1
(43) Pub. Date: Mar. 14, 2019

(54) METHOD, SYSTEM, AND DEVICE THAT INVOKES A WEB ENGINE

(71) Applicant: Alibaba Group Holding Limited, George Town (KY)

(72) Inventors: Donglei Wu, Beijing (CN); Ke Cheng, Shanghai (CN); Hongbo Min, Shanghai (CN)

(21) Appl. No.: 16/124,023

(22) Filed: Sep. 6, 2018

Related U.S. Application Data
(63) Continuation-in-part of application No. PCT/CN2017/074722, filed on Feb. 24, 2017.

(30) Foreign Application Priority Data
Mar. 9, 2016 (CN) 201610134803.5

(51) Int. Cl. G06F 17/30; G06F 17/22; G06F 9/451

(52) U.S. Cl. CPC G06F 17/30899; G06F 9/451; G06F 17/2247

(57) ABSTRACT

The present application discloses a web engine startup method, comprising: displaying a transition image; starting up the web engine; and displaying page content; wherein in displaying page content, said web engine reuses the graphics buffer used to display the transition image; said graphics buffer is used to store the outputted user interface data for the display service module to display it. The present application simultaneously offers a web engine startup device. The web engine startup method offered in the present application is used because the same graphics buffer is reused in the web engine startup process and the transition image display process; therefore, not only is fast feedback to user input achieved during the web engine startup process, but there is also no additional buffer overhead generated as a result of displaying the transition image, which conserves memory utilization.

### CROSS REFERENCE TO OTHER APPLICATIONS

This application is a continuation-in-part of and claims priority to International (PCT) Application No. PCT/CN2017/074722 entitled WEB ENGINE STARTING METHOD AND DEVICE, filed Feb. 24, 2017 which is incorporated herein by reference for all purposes, which claims priority to China Application No. 201610134803.5 entitled A WEB ENGINE STARTUP METHOD AND DEVICE, filed Mar. 9, 2016 which is incorporated herein by reference for all purposes.

### FIELD OF THE INVENTION

The present application involves the field of web engine technology. In particular, the present application relates to a method, system, and device for invoking a web engine.

### BACKGROUND OF THE INVENTION

Personal computers, smartphones, and other such terminal devices have become widely adopted and integral to users' lives. According to related art, users typically launch browsers or web applications (e.g., web-based applications) by clicking icons or pressing keys corresponding to the browsers or web applications. For example, users provide a manual input to the terminal in connection with instructing the terminal to perform a specific function. Browsers or web applications typically are required to start up a web engine (also referred to as a browser engine) and the web engine performs rendering of a page based on Hypertext Markup Language (HTML), Extensible Markup Language (XML), or image resources that are returned to the terminal by the server. The terminal then generally outputs the rendered page to a display device to present the page to the user.

The process for starting up web engines typically comprises: downloading web resources such as webpage files, converting the webpage files into a Document Object Model (DOM) tree, building a render tree used to render the DOM Tree, performing layout processing of each node in the render tree, determining a display location on a screen of the terminal, traversing each node of the render tree to draw the object at the node of the render tree to the graphics buffer, instructing a module providing display services (e.g., typically referred to as the display system or the graphics system) to render and output the data contained in the graphics buffer to the hardware buffer of the display device (e.g., the hardware display buffer), and displaying page content via the display device.

Because the process for starting up a web engine according to related art requires the execution of the operations described above, such a process is generally relatively time-consuming. For example, the time for performing the process for starting up a web engine is generally in excess of 300 ms. In addition, during the period of time from a time when a user inputs an input corresponding to an operation to launch the web application or browser to a time at which page content is displayed, the screen of the terminal generally displays no content (e.g., a blank screen is displayed, or a black and/or white screen is displayed). The lack of display of content during the time when the process for starting up the web engine is performed can cause the user to believe that the input operation has not obtained any feedback (e.g., that the terminal has crashed or the application has hung up). As a result, the user may even repeat the same operation, which thus affects both the server's performance and the user's experience.

According to some related art, to address the above-identified problem of a lack of content being displayed during the process for starting up the web engine, some terminal devices employ an additional separate window specifically used to display a transition animation. The display of the transition animation is generally performed concurrent with the startup of the web engine. As an example, terminals (e.g., smartphones) using the Android® operating system use the window management process to display transition animations. Because the display of transition animations occupies an additional buffer, the memory (and processing) overhead is increased (e.g., from the perspective of the system as a whole), and the system's performance is slowed down.

In view of the above, there is a need for a method, device, and system for invoking a web engine.

### BRIEF DESCRIPTION OF THE DRAWINGS

Various embodiments of the invention are disclosed in the following detailed description and the accompanying drawings.

FIG. 1 is a flowchart of a method for invoking a web engine according to various embodiments of the present application.

FIG. 2 is a method for providing a transition image according to various embodiments of the present application.

FIG. 3 is a schematic diagram of multithread processing flows according to various embodiments of the present application.

FIG. 4 is a functional diagram of a computer system for invoking a web engine according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Many specific details are set forth in the description below to facilitate full understanding of the present application. However, the present application can be implemented using many other means different from the means described herein, and persons skilled in the art can make similar extensions without departing from the intension of the present application; therefore, the present application is not limited by the specific embodiments disclosed below.

As used herein, a terminal generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

Various embodiments provide a method, system, and/or device for invoking a web engine. As an example, invoking a web engine can comprise launching or starting up a web engine. For ease of understanding, a brief description of the related technology is provided.

Applications are configured to run (e.g., be executed) on terminals. Terminals are configured to provide information to a user according to different modes or mediums in connection with enabling the user to interact with the terminal. For example, a terminal can comprise a display device and display user interface data (UI data) on the display device. Applications or systems can write the user interface data that is to be displayed or updated to respective graphics buffers thereof.

As used herein, a graphics buffer refers to blocks of memory used for display. A graphics buffer can be managed by dedicated modules, such as a graphics buffer management module. The graphics buffer management module can be a hardware and/or software module. The graphics buffer management module is configured to store and manage one or more graphics buffers. As an example, graphics buffers can be allocated to the graphics buffer management module based on requests from the application running on a terminal or system of the terminal (e.g., an operating system of the terminal). For example, an operating system of the terminal can have a graphics buffer manager (e.g., SurfaceFringer of an Android® operating system). In some embodiments, graphics buffers are configured to store UI data such as UI data pending display. The UI data pending display can correspond to pixel data of a user interface to be displayed. A size of a graphics buffer can be based at least in part on a display resolution of a display of a terminal. For example, the display resolution is different for different terminals. Accordingly, the sizes of graphics buffers for terminals having displays with different display resolutions are different. As an example, for a terminal having a resolution ratio of 1080 p, the size of each graphics buffer is 8 MB.

After an application or system provides (e.g., writes) UI data to a respective graphics buffer, the module configured to provide a display service (e.g., the display service module) is notified. The display service module can be configured to perform calculations and/or merging of the UI data included in the graphics buffer corresponding to the application or system. The display service module can be configured to finally render (e.g., to finally compose) and outputs rendered UI data to the hardware buffer of the display device. The display device (of the terminal) can provide the user interface display function based at least in part on the rendered UI data comprised in the hardware buffer of the display device. The display service module can perform one or more of the above-described processes (e.g., functionalities) using software, hardware, or both software and hardware.

According to various embodiments, graphics buffers can be reused. For example, the graphics buffers can be reused in connection with the invoking (e.g., startup or launch) of the web engine and/or the display of the transition image. The web engine such as a web browser (e.g., Chrome, Firefox, etc.). The web engine can comprise a render engine such as WebKit. Various embodiments provide relatively more response (e.g., faster feedback) to a user in response to a user input or user command based at least in part on the reuse of the graphics buffer. For example, because the startup of a web engine is relatively time-consuming, a transition image display method can be used. As used herein, a transition image corresponds to an image provided by the terminal during the startup (e.g., launching) of the web engine. As used herein, a splash module is configured to cause the display device of the terminal to display the transition image. A splash corresponding to an application is content that is first displayed or initially displayed before application content is displayed. The splash module can be invoked in response to a startup (e.g., a launch) of the application. The splash module can be implemented via hardware and/or software. The splash module can cause the display device to display the transition image based at least in part on providing the display device with information comprising the transition image, and/or information corresponding to the transition image (e.g., information pertaining to a location from which the transition image can be obtained). According to various embodiments, no repeated requests for new graphics buffers (e.g., requests for a new graphics buffer, or requests sent to a new graphics buffer) are issued (or processed) during the process of starting up (e.g., launching) the web engine. In some embodiments, the graphics buffer used in connection with providing a transition image is reused for the processing of the display of the page content (e.g., page content associated with a request corresponding to the invocation of the web engine). Reuse of the graphics buffer reduces resource and processing overhead associated with generating or processing additional graphics buffers. For example, the reuse of a graphics buffer avoids (or at least reduces) the overhead for the generation of additional graphics buffer, and thereby reduces the utilization of memory resources. In some embodiments, the length of time for the startup process of a web engine can be reduced by 20-50 ms in contrast to conventional implementations. For example, various embodiments save a time of allocating a buffer. For example, the graphics buffer associated with the splash module (e.g., that provides the transition image) is reused in connection with processing the display of the display content.

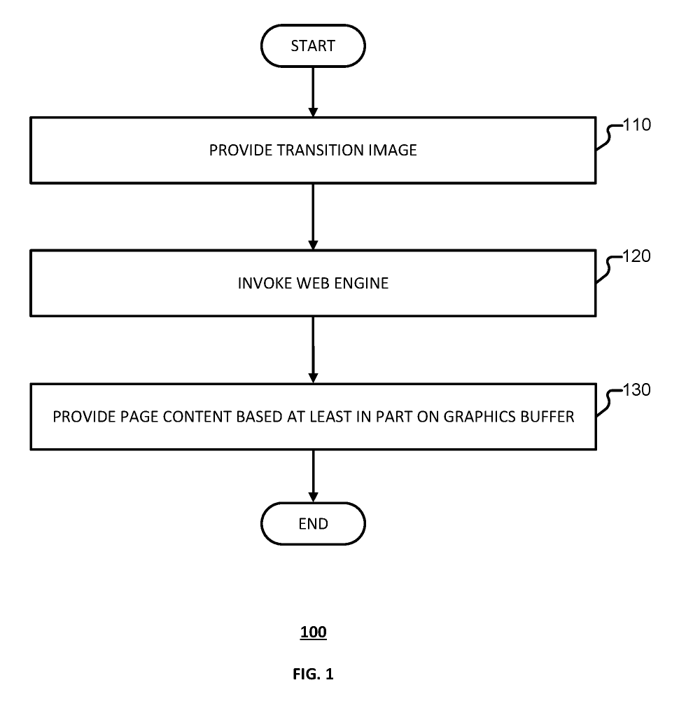

FIG. 1 is a flowchart of a method for invoking a web engine according to various embodiments of the present application.

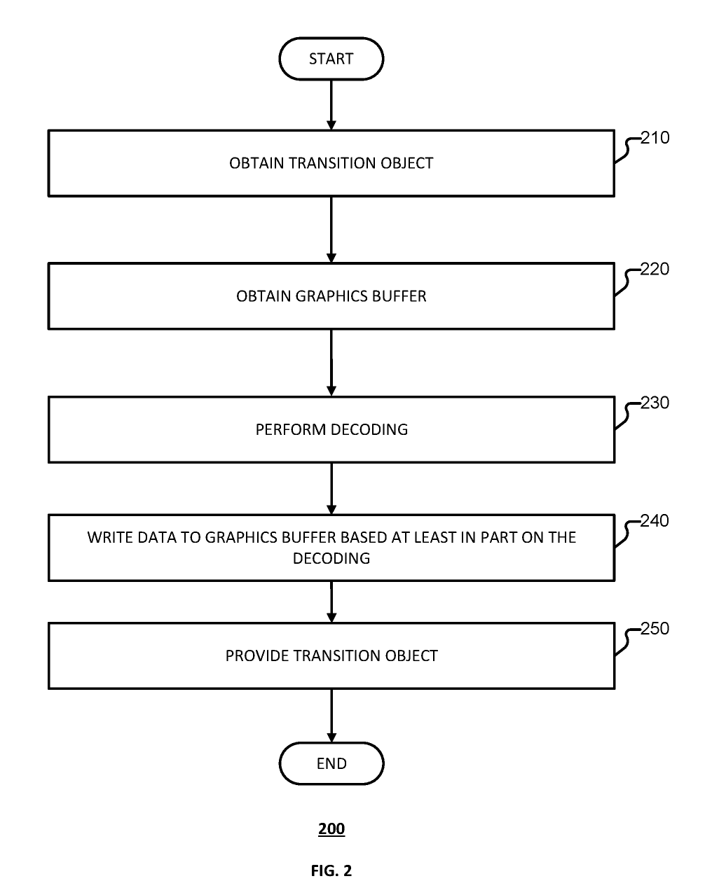

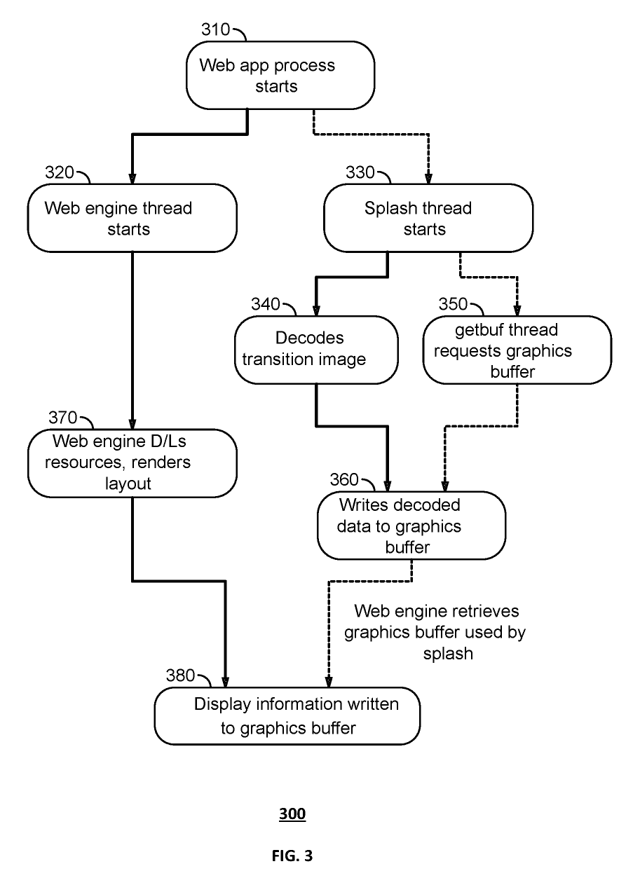

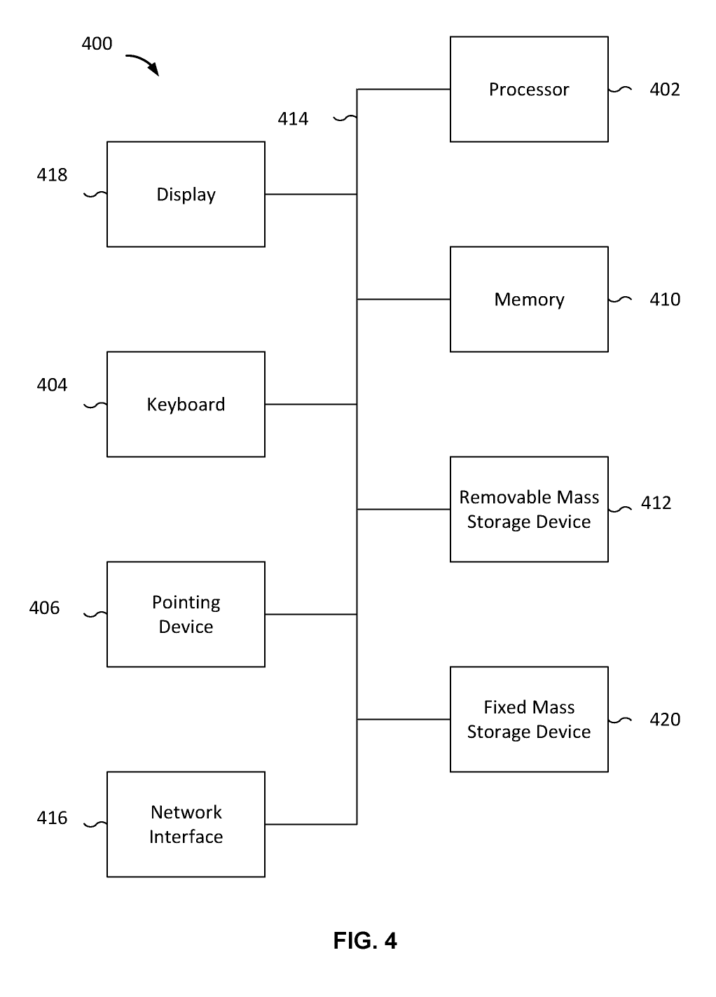

Referring to FIG. 1, process 100 for invoking a web engine is provided. Process 100 can be implemented in connection with process 200 of FIG. 2 and/or process 300 of FIG. 3. Process 100 can be implemented at least in part by computer system 400 of FIG. 4.

At 110, a transition image is provided. For example, the terminal can display the transition image via a display device. In some embodiments, the transition image is obtained from a graphics buffer that stores the transition image. The graphics buffer can specifically correspond to a buffer in which the transition image is stored. In response to obtaining the transition image from the graphics buffer, the terminal can provide (e.g., via the display device) the transition image. The transition image can be provided by the terminal in connection with an invocation (e.g., launching or start up) of a web engine (e.g., a web browser or another web-based application). In response to receiving an instruction to launch (e.g., open) the web engine, the transition image is provided. A splash module of the terminal can obtain the transition image and/or cause (e.g., instruct) the terminal to display the transition image.

According to various embodiments, the transition image already rendered and in response to a startup (e.g., a launch) of the web engine (e.g., or application) the rendered image is obtained and displayed. The rendered image can be stored (e.g., locally) in advance of the web engine being launched. In some embodiments, the providing of the transition image comprises obtaining information pertaining to the transition image, and rendering the transition image using the obtained information pertaining to the transition image.

A browser and/or a web application can be invoked in response to a user command. For example, the browser and/or web application can be invoked in response to a user input to the terminal. The input to the terminal can correspond to a predefined input that is associated with invoking (e.g., starting up, launching, etc.) the browser and/or web application. For example, a first predefined input can correspond to invoking a browser, and/or a second predefined input can correspond to invoking a web application. The input corresponding to invoking the browser and/or web application can be input to a user interface (e.g., a graphical user interface displayed on a touchscreen) of the terminal. For example, the input corresponding to invoking the browser and/or web application is selection of (e.g., clicking on) an icon displayed on the screen of the terminal. As another example, the input corresponding to invoking the browser and/or web application is selection of a key or button displayed on the terminal. In response to a user invoking (e.g., starting up) a browser or web application, the terminal launches a corresponding application process. A main thread of the application process can comprise an invocation of (or a command for) a splash module to display a transition image. The transition image can be displayed while the browser and/or web application is starting up. The browser and/or web application (or the web engine corresponding to the browser or web application) is started up to undertake display of page content to be displayed by the browser and/or web application. The graphics buffer used by the splash module in connection with the display of the transition image can be maintained (e.g., not discarded) and reused in connection with display of the page content. For example, the browser and/or web application (or the web engine corresponding to the browser or web application) retrieves the graphics buffer previously used by the splash module when the splash module displayed the transition image, and the browser and/or application outputs the page content pending display to the graphics buffer (e.g., the terminal can use openGL to render the page content pending display into the graphics buffer). The retrieving the graphics buffer can comprises using the graphics buffer (e.g., identifying an address or location of the graphics buffer and using the address or location of the graphics buffer in connection with using the graphics buffer).

Various embodiments improve the loading and display of page content. For example, in order to be able to start up the web engine more quickly to facilitate a user's viewing of page content as quickly as possible, various embodiments use a multithread asynchronous processing method for the startup of the splash module and the startup of the browser or other application (e.g., the web engine corresponding to the browser or other application) is implemented. According to various embodiments, an application process creates a separate splash thread used to execute the splash module, and a task of starting up the browser or other application (e.g., the web engine corresponding to the browser or other application) is accomplished by the main thread (which can also be referred to herein as the web engine thread). According to various embodiments, the main thread and the splash thread are comprised in the same process. The execution of the splash module is used in connection with displaying the transition image. Because the splash module is a lightweight module (e.g., relative to the web engine), using multithread asynchronous processing for the startup of the splash module and the startup (or processing) of the browser or other application (e.g., the web engine corresponding to the browser or other application) enables a terminal to display page content very quickly. In addition, using multithread asynchronous processing for the startup of the splash module and the startup (or processing) of the browser or other application (e.g., the web engine corresponding to the browser or other application) allows the web engine startup process to be unimpeded (e.g., no lock is implemented in relation to the main thread).

In some embodiments, the splash module displays the transition image according to a preset color scheme. For example, the preset color scheme designates the display of a plurality of colors arranged according to specified rules. The specific rules according to which the plurality of colors are arranged can correspond to an indication of colors displayed by an application, etc. In some embodiments, a graphics buffer is obtained and data is written to the graphics buffer based at least in part on the preset color scheme. The graphics buffer can be obtained in response to the graphics buffer management module requesting the graphics buffer. In response to the graphics buffer being obtained, data is written to the graphics buffer according to the preset color scheme. The data written to the graphics buffer according to the preset color scheme is used in connection with displaying the transition image corresponding to the color scheme. In some embodiments, the transition image is displayed, and if no transition image is displayed or available, then the corresponding color scheme is displayed.

In some embodiments, the transition image that is displayed is based on a transition image file. The transition image file can be stored locally at the terminal. For example, the transition image file can be predefined for the terminal, the browser, and/or the application. Different applications can have different corresponding transition images (and thus different corresponding transition image files can be stored). Display of the transition image based at least in part on a transition image file can increase the aesthetic quality of the transition image, and/or provide specified information in the transition image. Specified image provided in connection with the transition image can include application symbols, slogans, trademarks, identifiers for the application, etc. The transition image file can be a pre-designed image file, for example: a bmp file or a jpg file. Other file formats of transition image files can be implemented.

According to various embodiments, process 200 of FIG. 2 is implemented in connection with 110 of process 100 of FIG. 1.

FIG. 2 is a method for providing a transition image according to various embodiments of the present application.

Referring to FIG. 2, process 200 for providing a transition image is provided. Process 200 can be implemented in connection with process 100 of FIG. 1 and/or process 300 of FIG. 3. Process 200 can be implemented at least in part by computer system 400 of FIG. 4.

At 210, a transition object is obtained. The transition object can correspond to a transition image. In some embodiments, the terminal obtains the transition image from a local storage of the terminal. The transition image can be stored on the terminal as a transition image file. In some embodiments, before the startup of the web engine or application, the transition image file is stored (e.g., on a disk of the terminal). The transition image file can be a pre-designed image file, for example: a bmp file or a jpg file. Other file formats of transition image files can be implemented.

In some embodiments, the transition image is obtained in response to invocation (e.g., starting up, launching, etc.) of a browser and/or web application. For example, a splash module is invoked in response to invocation (e.g., starting up, launching, etc.) of a browser and/or web application. The splash module can comprise a set of instructions associated with display of the transition image. The splash module can obtain the transition object in response to being invoked. As further described below, the splash module can retrieve the transition image file using a variety of methods.

In some embodiments, the transition image (e.g., the transition image file) is obtained based at least in part on the path of a configuration file corresponding to an application (e.g., web application) for which the transition image is to be displayed. If invocation of the application is triggered by a command to start up the application (e.g., an input selecting an icon for the application), the splash module retrieves the transition image (e.g., the transition image file) based at least in part on the path designed in the configuration file of the application (e.g., the web application). According to various embodiments, the graphics buffer is reused only with respect to the same processes (e.g., same applications or types of applications). For example, in Android® operating systems, each application has a corresponding manifest configuration file, in which path information for the transition image can be configured (e.g., preset). If the user clicks an icon corresponding to the web application, in connection with the web application process being created, the path for the transition image is provided to (or accessible by) the splash module. The splash module can retrieve the transition image file based on the path provided in the configuration file.

In some embodiments, the transition image (e.g., the transition image file) is obtained based at least in part on a preset path corresponding to a browser (or a path corresponding to an application) for which the transition image is to be displayed. If a browser is invoked (e.g., started up), the splash module can retrieve the transition image file based on a preset path. As an example, the preset path can be stored in an application manifest, an operating system, or cloud config. For example, if the browser is invoked by a command to start up the browser, the splash module can obtain the transition image file based at least in part on the preset path.

At 220, a graphics buffer is obtained. In some embodiments, the obtaining the graphics buffer comprises allocating the graphics buffer (e.g., from the graphics processing unit manager). The terminal can obtain the graphics buffer in response to obtaining the transition object (e.g., the transition image file). In some embodiments, the splash module obtains the graphics buffer. The graphics buffer can be obtained in connection with sending a request for the graphics buffer to the graphics buffer management module. For example, the splash module can request the graphics buffer from the graphics buffer management module. The size of the graphics buffer can depend on a window size of an application. In some embodiments, the request for the graphics buffer can comprise one or more parameters or requirements for the desired graphics buffer. For example, the window size of the application, etc. can be provided in connection with the request for the graphics buffer.

The splash module sends a request to the graphics buffer management module requesting a graphics buffer. In response to receiving the request for the graphics buffer, the graphics buffer management module can search for an idle graphics buffer among the graphics buffers managed by the graphics buffer management module. In response to locating an idle graphics buffer, the located graphics buffer can be returned to the splash module. For example, if the graphics buffer management module finds an idle graphics buffer, the graphics buffer management module returns the idle graphics buffer to the splash module. If an idle graphics buffer is not located, a new graphics buffer can be created. For example, in response to determining that an idle graphics buffer is not available, the graphics buffer management module can request for memory to create an idle graphics buffer. The graphics buffer management module can generate the request for a new idle graphics buffer, and provide the request for the new idle graphics buffer to a process that manages memory of the terminal. In response to the new graphics buffer being generated, the new graphics buffer can be provided to the splash module. For example, the graphics buffer management module can provide the new graphics buffer to the splash module in response to the graphics buffer management module receiving the new graphics buffer or an indication that the new graphics buffer is provided. In some embodiments, the graphics buffer management module returns to the splash module a memory address for the graphics buffer. The splash module can execute the operation to write data to the graphics buffer based at least in part on the retrieved memory address.

According to various embodiments, obtaining the graphics buffer comprises obtaining information pertaining to a graphics buffer allocated to a process for providing a transition image. As an example, the graphics buffer allocated to the process for providing the transition image is the graphics buffer allocated to the splash module. As an example, the information pertaining to the graphics buffer comprises a starting memory address corresponding to the graphics buffer and a buffer size. The transition image file can be written to the memory at the memory address corresponding to the graphics buffer. For example, the memory at the memory address corresponding to the graphics buffer can be used in connection with providing a transition image, and again in connection with providing page content. As another example, the information pertaining to the graphics buffer comprises an identifier associated with a graphics buffer. A location (e.g., a memory address) corresponding to the graphics buffer can be determined based at least in part on querying a mapping of identifiers of graphics buffers to memory addresses of graphics buffers.

At 230, decoding is performed. The terminal can decode information associated with the transition image file. In some embodiments, the terminal reads the transition image file and performs a decoding operation with respect to information corresponding to the transition image file. For example, the transition image file can be decoded. As an example, the decoding of the information transition image file can comprise converting an encoded format to an original information set. In some embodiments, a base64 image decoder is implemented.

The splash module can read the retrieved transition image file, and executes the corresponding decoding operation based on the data storage format of the transition image file. Data comprised in the transition image file can be converted into a format that a display device of the terminal can use in connection with providing a display corresponding to the transition image file. For example, the splash module converts data comprised in the transition image file into color values corresponding to the RGB color format. The splash module can convert the format of a subset of the data obtained via decoding of the transition image file. In some embodiments, the decoded information pertaining to the transition image file can be saved and reused in subsequent launching of the web engine (or application).

At 240, data is written to the graphics buffer. In some embodiments, the data written to the graphics buffer comprises some or all of the data obtained in connection with decoding the transition image file. The data can be written to the graphics buffer in response to the decoding of the transition image file. In some embodiments, the terminal uses a memory address corresponding to the graphics buffer in connection with writing the data to the graphics buffer. The data can be written to the graphics buffer in connection with the display of the transition image. For example, the data written to the graphics buffer comprises information that the terminal uses to display the transition image.

As an example, the splash module writes the decoded data to the graphics buffer in order to display the transition image on the display device. In some embodiments, the terminal (e.g., the display service module) detects update events for the graphics buffer. The update events for the graphics buffer can comprise an image change (e.g., a change to image information to be displayed). For example, the display service module can detect (e.g., by getting a notification) when data is written to the graphics buffer for the terminal to display. In some embodiments, the splash module notifies the terminal (e.g., the display service module) that data to be used in connection with providing a display is written to the graphics buffer. For example, the splash module provides the display service module with a notification upon completion of the writing of decoded data (e.g., corresponding to the transition image file) to the graphics buffer. According to various embodiments, the display service module is configured to output the data pending display that is comprised in the graphics buffer to the hardware buffer of the display device. In response to the data to be displayed being written (e.g., output) to hardware buffer of the display device, the display device can display the data to be displayed.

In order to provide a more user-friendly interaction method, an animation method can be used to display the transition image. For example, the terminal can display a transition animation. The terminal can display the transition animation while a browser and/or web application is loaded (e.g., start up). The animation method comprises controlling a display of the terminal to display the transition image (or providing the display with information to display the transition image) in a manner that includes any one or a combination of the following features: controlling gradient opacity (alpha), controlling gradient dimension telescoping (scale), controlling movement (translate), and controlling rotation (rotate). The types of features or types of animation to be used in connection with displaying a transition animation can be set in advance, and can be designated in the configuration file of the web application (or browser). In some embodiments, if a terminal implements the animation method, upon completion of writing data to the graphics buffer, the splash module provides a notification to the display service module to perform the corresponding computation and rendering of the data comprised in the graphics buffer, and to output the rendered data to the hardware buffer of the display device. In response to a determination that the rendered data is output (e.g., written) to the hardware buffer of the display device, the display device displays the transition image while applying the animation effects. For example, through gradual adjustment of the display location (e.g., changing where the transition image is centered), a moving animation effect is implemented.

At 250, the transition object is provided. In some embodiments, providing the transition object comprises displaying the transition image. The terminal can display the transition image in response to determining that the data is written to the hardware buffer for the display device (or another buffer used by the terminal in connection with providing data to the display of the terminal for display). The data written to the hardware buffer can correspond to rendered data based on the decoded information obtained based at least in part on the transition image file. The transition object can be displayed based at least in part on a predefined transition animation. For example, one or more animation effects can be applied to the transition image for display by the terminal.

According to various embodiments, the splash module completes operations to request the graphics buffer (e.g., request for allocation of a graphics buffer), decode the transition image, and write the decoded data to the graphics buffer in a splash thread separately created for display of the transition image.

According to various embodiments, the transition image is displayed in connection with a multithreading processing. For example, display of the transition image can be performed concurrently with one or more other processes (e.g., loading of the browser and/or application). The use of multithreading processing enables the terminal to quickly display the transition image, and provide prompt feedback to the user. As an example, after the splash thread is launched, a getbuf thread is created, and the splash thread obtains the transition image file (e.g., a cached image) and decode the transition image file, while the getbuf thread executes the operation to request the graphics buffer, and provides the memory address of the retrieved graphics buffer to the splash thread via the inter-thread data sharing mechanism or communication mechanism (e.g., Java wait, notify, and notifyAll calls), and the splash thread writes the decoded data to the graphics buffer. The transition image is quickly provided to the user. In some embodiments, in subsequent launches of the splash thread, a cached decoded information pertaining to the transition image file is obtained and provided to the graphics buffer.

Returning to process 100 of FIG. 1, at 120, a web engine is invoked (e.g., a web app startup such as a launch of a browser). In some embodiments, the web engine is associated with the browser and/or the web application. As an example, the web engine can be a module or processing component of the browser and/or the web application. As another example, the web engine is a process running on the operating system that can be called by the browser and/or the web application.

At 130, page content is provided. The page content can be provided based at least in part on the graphics buffer. For example, the page content can be based at least in part on data stored in the graphics buffer. The graphics buffer used to store the data from which page content is generated can be the same as the graphics buffer used in connection with loading and displaying the transition image. The providing of the page content can comprise displaying the page content on a screen of the terminal. In some embodiments, the page content is provided in the browser and/or web application that is invoked (e.g., in connection with the display of the transition image).

According to conventional art, after the web engine is started up, the necessary initialization operations are executed first, whereupon the following operations can typically be executed: downloading of the page files pending display (e.g., html files) and the various resources involved with the page files; analyzing the page files and converting the page files to a DOM tree; creating a render tree used to render the DOM tree based on CSS and other style information, the nodes of the render tree typically corresponding to the visible portions of the page content, and typically comprising arrays that include colors, dimensions, and other display attributes, and the sequence of the arrays being consistent with the display sequence; layout processing of the nodes in the render tree to determine a corresponding display location on the screen; and finally, traversing the render tree to draw the corresponding nodes to the graphics buffer requested by the web engine, in order to present page content on the display device.

In contrast, according to various embodiments of the present application, in the course of executing the original processing process to display page content, the web engine reuses the graphics buffer used at 110. In some embodiments, the graphics buffer requested and/or used in connection with displaying the transition image is reutilized in the web engine startup process. Because the graphics buffer is reused (e.g., for display of the transition image and the page content), no additional buffer overhead is necessary. For example, no additional buffer overhead is created for the purpose of displaying the transition image, thus conserving memory utilization. The web engine processing process is described further below.

According to various embodiments, the web engine generates a DOM tree and a render tree based on the downloaded resources (e.g., resources pertaining to the page content), and lays out the nodes of the render tree to determine the display location on the screen. During the web engine processing process, the web engine determines whether one or more preset conditions are satisfied. In response to a determination that the one or more presets are satisfied, the graphics buffer used in connection with display of the transition image is obtained, and laid-out page content (e.g., for each of the laid-out nodes included in the render tree) is drawn to (e.g., written to) the graphics buffer.

In response to a determination that the one or more preset conditions are satisfied, the graphics buffer can be reallocated for use in connection with display of the page content. For example, in response to a determination that the one or more preset conditions are satisfied, the graphics buffer can be reallocated (e.g., from the splash thread, or from use in connection with displaying the transition image) to the web engine for use in connection with display of the page content. In some embodiments, reallocating the graphics buffer for use in connection with display of the page content comprises providing a process (e.g., that controls display of the page content) with the information associated with the graphics buffer. The information associated with the graphics buffer can comprise a memory address corresponding to the graphics buffer.

In some embodiments, obtaining the graphics buffer that is used in connection with the display of the transition image refers to obtaining (e.g., determining) the memory address and size information of the graphics buffer. In some embodiments, by implementing the multithread asynchronous processing, the web engine thread uses the inter-thread data sharing mechanism or communication mechanism to obtain the memory address and size information of the graphics buffer from the splash thread.

The one or more preset conditions can comprise the display of the transition image being complete. In some embodiments, determination that display of the transition image is complete is based at least in part on determining that the corresponding information is provided to a hardware buffer. In some embodiments, after display of the transition image is complete (e.g., in response to a determination that the display of the transition image is complete), the splash thread sends a notification to the web engine thread, and the web engine thread obtains, from the splash thread, the graphics buffer that was used in connection with display of the transition image and draws the laid-out page content to the graphics buffer. In some embodiments for which an animation method to display the transition image is implemented, the use of the one or more preset conditions (e.g., the display of the transition image being complete) in connection with writing the laid-out page content to the graphics buffer ensures the integrity of the transition animation display process (e.g., that the transition animation is fully provided), and enables presentation of page content to the user as quickly as possible.

In order to provide a complete first screen information to the user, and avoid the appearance of a blank screen or partially blank screen, in various embodiments, complete first screen information is displayed. Complete first screen content can refer to page content that is fully rendered (e.g., so that the entire page to be displayed is being displayed rather than a portion of the page to be displayed being displayed). In connection with providing a complete first screen information, the one or more preset conditions comprise the display of the transition image being complete, and dimensions of the drawable area satisfying first screen requirements. The first screen requirements can comprise a display of the image, an indication that the information is written to the buffer (e.g., when the page buffer is ready).

As used herein, the drawable area can refer to: the area of the display screen corresponding to the laid-out nodes of the render tree. The first screen (or above the fold) refers to the first screen that is presented on the display screen after the page is opened (e.g., the view that can be seen by the user without executing scrolling operations). The first screen can be the first screen that is presented on the display screen after the page is opened after the transition screen/image is displayed.

According to various embodiments, during the download of resources (e.g., corresponding to the page content to be displayed) and rendering and layout processes, the web engine determines (e.g., computes) the dimensions of the drawable area. The web engine can determine the dimensions of the drawable area based at least in part on the location information of the laid-out page content. As an example, the location information can be stored in an application manifest, etc. In some embodiments, during the process of laying out the nodes in the render tree (e.g., the nodes in the render tree can be laid out one by one such as on a node-by-node basis), whenever the layout of a node is completed, the dimensions of the drawable area are calculated for the display locations on the screen based on the laid-out node. In response to determining (e.g., detecting) that the display of the transition image is complete, if current dimensions of the drawable area are less than (e.g., are yet to reach) the size of the first screen, then layout of the nodes in the render tree continues until the dimensions of the drawable area satisfy first screen requirements (e.g., the dimensions of the drawable area are greater than or equal to the size of the first screen), before the graphics buffer can be retrieved from the splash thread, and the laid-out first-screen information (e.g., page content) can be drawn to the graphics buffer. As an example, the preset condition corresponding to the dimensions of the drawable area satisfying first screen requirements can be deemed to be satisfied in response to determining that current dimensions of the drawable area (e.g., that are determined as each node in the render tree is laid out) are equal to (or greater than) the size of the first screen. As another example, the preset condition corresponding to the dimensions of the drawable area satisfying first screen requirements is deemed to not be satisfied in response to determining that current dimensions of the drawable area (e.g., that are determined as each node in the render tree is laid out) are less than the size of the first screen.

According to various embodiments, because the web engine has already prepared the first screen content (e.g., before such content is written to the graphics buffer), the content displayed to the user by writing to the graphics buffer corresponds to complete first screen content, and will not result in the appearance of a blank screen or partially blank screen. Accordingly, a good browsing experience for the user is ensured from the perspective of the visual experience, realizing a seamless switch from display of the transition image to display of page content.

Various embodiments enable the display of the first screen page content as quickly as possible. The one or more preset conditions can comprise the dimensions of the drawable area satisfying first screen requirements. During the process of downloading resources (e.g., resources corresponding to the page content to be displayed), rendering, and layout, the terminal (e.g., the web engine) determines (e.g., computes) the dimensions of the drawable area based at least in part on the location information of the laid-out page content. In some embodiments, the preset condition the satisfaction of which invokes (e.g., triggers or causes) the graphics buffer to be obtained (e.g., by the web engine) from the splash thread is: the dimensions of the drawable area satisfying the first screen requirements. In response to determining that the dimensions of the drawable area obtained by the web engine through calculations are greater than or equal to the size of the first screen, the splash thread can be notified that the first screen page content is ready (e.g., a notification can be sent to the splash thread to provide the web engine with the graphics buffer), the graphics buffer can be obtained (e.g., from the splash thread via an API call), and the first screen page content can be written to the graphics buffer. In some embodiments, in response to determining that the dimensions of the drawable area obtained by the web engine through calculations are greater than or equal to the size of the first screen, the graphics buffer can be obtained and page content can be written thereto without the terminal (e.g., the web engine) waiting for the display of the transition image to be complete.

Various embodiments enable quick display of the first screen page content to the user. If an animation effect is used in connection with display of the transition image (e.g., if the animation method is used to display the transition image), various embodiments reduce the time that the user views the transition animation, and presents (e.g., displays) the page content of interest to the user (e.g., as determined based on a user request or based on the user launching the corresponding browser and/or application) as quickly as possible. For example, the page content to be presented is provided when such page content is available (e.g., corresponding processing is complete), rather than based on the animation effect being complete.

Because the various page elements comprised in a web page can be layered, processing the page content can proceed according to a layered approach. As an example: the bottom layer of the web page is the window, and images are set up on top of the bottom layer, and buttons, links, etc. are set up on top of the images. The performing rendering and layout and preparing drawable page content can comprise a layered approach. In response to determining that the one or more preset conditions are satisfied and the graphics buffer is obtained, the content to be drawn that has been prepared in layers can be fused (combined) using the relationships among the layers (e.g., the superimposed coverage relationships between layers), and the fused data can be written to the graphics buffer retrieved from the splash thread. Writing the page content to the graphics buffer as fused data (e.g., among the layers) can reduce repetitive write operations to the graphics buffer and thereby increase execution efficiency.

According to various embodiments, using a web engine startup method that reuses the graphics buffer, in relation to providing a transition image and providing page content, improves the efficiency of the display of the page content. Because the same graphics buffer is reused in the web engine startup process and the transition image display process, rapid feedback (e.g., response) to user input can be realized (during the web engine processing process), and no additional buffer overhead is required as the result of displaying the transition image, thus conserving memory utilization. In some embodiments, no unnecessary additional graphics buffer overhead is generated (or additional graphics buffer overhead is reduced) because the graphics buffer used in connection with display of the transition image is also used in connection with display of the page content.

FIG. 3 is a schematic diagram of multithread processing flows according to various embodiments of the present application.

Referring to FIG. 3, process 300 for multithread processing is provided. Process 300 can be implemented in connection with process 100 of FIG. 1 and/or process 200 of FIG. 2. Process 300 can be implemented at least in part by computer system 400 of FIG. 4.

At 310, an application process is invoked (e.g., starts). For example, a web application process or a process for a browser can be invoked. The application process can be invoked in response to the application being launched (e.g., started up). For example, in response to a user selecting an icon corresponding to the application, the corresponding application process is invoked.

In response to the web application process being invoked at 310, process 300 can proceed to 320 and/or 330. For example, 320 and 330 can be performed concurrently. In some embodiments, a processing path comprising 320 and 370 can be performed contemporaneously (e.g., concurrently or in parallel) with a processing path comprising 330, 340 and/or 350, and 360.

At 320, a web engine thread is invoked (e.g., started). The web engine thread can be invoked in response to the application process being invoked.

At 370, the web engine downloads resources and renders a layout. The downloaded resources can correspond to a page for which the page content is to be displayed.

At 330, a splash thread is invoked (e.g., started). The splash thread can be invoked in response to the application process being invoked.

In response to the splash thread being invoked at 330, process 300 can proceed to 340 and/or 350. For example, 340 and 350 can be performed concurrently. In some embodiments, a processing path comprising 340 can be performed contemporaneously (e.g., concurrently or in parallel) with a processing path comprising 350.

At 340, a transition image is decoded. For example, information pertaining to the transition image to be displayed is decoded.

At 350, a getbuf thread requests a graphics buffer.

At 360, decoded data is written to the graphics buffer. The decoded data can correspond to information obtained in connection with decoding the transition image.

At 380, display information is written to the graphics buffer. The display information corresponds to page content to be displayed (e.g., by the application that is invoked such as a browser or web application). For example, the laid out page is written to the graphics buffer.

FIG. 4 is a functional diagram of a computer system for invoking a web engine according to various embodiments of the present application.

Referring to FIG. 4, computer system 400 for invoking a web engine is provided. Computer system 400 can implement at least part of process 100 of FIG. 1, process 200 of FIG. 2, and/or process 300 of FIG. 3.

Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418).

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data, and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown). The memory can be a non-transitory computer-readable storage medium.

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storage device 412 and fixed mass storage 420 generally store additional programming instructions, data, and the like that typically are not in active use by the processor 402. It will be appreciated that the information retained within mass storage device 412 and fixed mass storage 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

The present application is described based on the flowcharts and/or block diagrams of the method, devices (system), and computer program products of the embodiments of the present application. It should be understood that each flowchart and/or block diagram within the flowcharts and/or block diagrams and combinations of flowcharts and/or block diagrams within the flowcharts and/or block diagrams can be realized by computer program commands. These computer program commands can be provided to general-purpose computers, special-purpose computers, embedded processors, or the processors of other programmable data processing devices, to give rise to a machine which, through commands executed by the processor of a computer or other programmable data processing equipment, gives rise to a device used to realize the functions designated in one or more processes in a flowchart and/or one or more blocks in a block diagram.

These computer program commands can also be stored in computer-readable memory capable of guiding a computer or other programmable data processing device to operate in a specified manner, so that the commands stored in such computer-readable memory give rise to a manufactured product that includes the commanded devices, and the commanded devices realize the functions designated in one or more processes and/or one or more blocks in a flowchart.

These computer program commands can also be loaded on a computer or other programmable processing device, causing a series of operational steps to be executed on the computer or other programmable device to give rise to computer-realized processing, so that the commands executed on the computer or other programmable device provide the steps to realize the functions designated in one or more processes and/or one or more blocks in a flowchart.

Although the present application has been disclosed using the preferred embodiments above, they are not intended to limit the present application, and any person skilled in the art can make possible changes and revisions without departing from the spirit and scope of the present application; therefore, the scope of protection of the present application should be based on the scope defined in the claims of the present application.

In one typical configuration, computer equipment comprises one or more processors (CPUs), input/output interfaces, network interfaces, and memory.

Memory may include such forms as volatile memory, random access memory (RAM), and/or non-volatile memory in computer-readable media, such as read-only memory (ROM) or flash memory (flash RAM). Memory is an example of computer-readable media.

Computer-readable media include permanent and impermanent, removable and non-removable media that can realize the storage of information by any method or technology. Information can be computer-readable commands, data structures, program modules, or other data. Examples of computer storage media include, but are not limited to, phase-change random access memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical memory, magnetic cassette, magnetic tape or magnetic disk storage or other magnetic storage equipment, or any other non-transmission medium that can be used to store information that can be accessed by computer equipment. According to the definitions in this document, computer-readable media do not include transitory computer-readable media, such as modulated data signals and carrier waves.

Persons skilled in the art should understand that the embodiments of the present application can be provided as methods, systems, or computer program products; therefore, the present application can be realized in the form of embodiments consisting entirely of hardware, embodiments consisting entirely of software, or embodiments that combine hardware and software. Moreover, the present application can be realized in the form of computer program products implemented on one or more computer-usable storage media (including, but not limited to, magnetic disk memory, CD-ROM, optical memory, etc.) containing computer-usable program code.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
displaying, by a terminal, a transition image, wherein a graphics buffer is used in connection with displaying the transition image;
invoking, by the terminal, a web engine to render page content; and
displaying, by the terminal, the page content;
wherein the graphics buffer is reused in connection with displaying the page content.

2. The method of claim 1, wherein the page content comprises user interface data, and the user interface data is stored in the graphics buffer in connection with displaying the page content.

3. The method of claim 1, wherein the displaying the transition image comprises using one or more animation effects in connection with displaying the transition image.

4. The method of claim 3, wherein the one or more animation effects comprise one or more of: controlling a gradient opacity, controlling a gradient scaling, controlling a translation, and/or controlling a rotation.

5. The method of claim 1, further comprising:
obtaining the transition image in response to an application being invoked.

6. The method of claim 5, wherein the obtaining of the transition image and the displaying of the transition image are implemented concurrently with the invoking of the web engine.

7. The method of claim 5, wherein the obtaining the transition image and the displaying of the transition image are implemented concurrently with the invoking of the web engine, and the invoking of the web engine and the displaying of the page content are respectively implemented asynchronously in different threads of the application.

8. The method of claim 1, wherein the displaying of the transition image comprises:
obtaining a transition image file corresponding to the transition image;
obtaining the graphics buffer;
reading the transition image file;
decoding the transition image file; and
writing data obtained based at least in part on the decoding of the transition image file, the data being written to the graphics buffer, and the data being used in connection with display of the transition image.

9. The method of claim 8, wherein the obtaining of the graphics buffer comprises requesting the graphics buffer from a graphics buffer management module.

10. The method of claim 8, wherein the transition image is displayed in response to an invocation of an application, and the obtaining of the transition image file comprises retrieving the transition image file based at least in part on a path comprised in a configuration file of the application.

11. The method of claim 8, wherein the transition image is displayed in response to receiving a command to launch a browser, the obtaining of the transition image file comprises retrieving the transition image file based at least in part on a preset path.

12. The method of claim 8, wherein the obtaining of the graphics buffer is implemented in a different thread than a thread used to implement at least the obtaining of the transition image file and the displaying of the transition image.

13. The method of claim 1, wherein the displaying of the transition image comprises:
obtaining the graphics buffer; and
writing data to the graphics buffer according to a preset color scheme, wherein the transition image is displayed at least in part on the preset color scheme.

14. The method of claim 1, wherein one or more of the invoking the web engine and the displaying of the page content comprises:
downloading one or more resources corresponding to the page content;
rendering and laying out data corresponding to the page content;
determining whether one or more preset conditions are satisfied, wherein the determining whether the one or more present conditions are satisfied is implemented contemporaneously with the downloading of the one or more resources and the rendering and the laying out of data; and
in response to determining that the one or more preset conditions are satisfied:
obtaining the graphics buffer used in connection with the displaying of the transition image; and
writing laid-out page content to the graphics buffer.

15. The method of claim 14, wherein the one or more preset conditions comprise: the displaying of the transition image being complete.

16. The method of claim 15, further comprising:
determining dimensions of a drawable area based at least in part on location information of the laid-out page content, the determining of the dimensions being implemented contemporaneously with the downloading of the one or more resources and the rendering and the laying out of data;
wherein the one or more preset conditions comprise the displaying of the transition image being complete, and the dimensions of the drawable area satisfying one or more first screen requirements; and
wherein the writing of the laid-out page content to the graphics buffer comprises writing a laid-out first screen page content to the graphics buffer.

17. The method of claim 14, further comprising:
calculating dimensions of a drawable area based at least in part on location information of the laid-out page content, wherein the calculating the dimensions of the drawable area is implemented contemporaneously with the downloading of the one or more resources and the rendering and the laying out of data;
wherein the one or more preset conditions comprise the dimensions of the drawable area satisfying one or more first screen requirements, and
wherein the writing the laid-out page content to the graphics buffer comprises writing laid-out first screen page content to the graphics buffer.

18. The method of claim 14, wherein the rendering and the laying out of data corresponding to the page content proceeds in layers, and
wherein writing the laid-out page content to the graphics buffer comprises fusing page content laid out in layers and drawing a fused page content to the graphics buffer.

19. A device, comprising:
one or more processors configured to:
display a transition image, wherein a graphics buffer is used in connection with displaying the transition image;
invoke a web engine to render page content; and
display the page content, wherein the graphics buffer is reused in connection with displaying the page content; and
one or more memories coupled to the one or more processors, configured to provide the one or more processors with instructions.

20. A computer program product, the computer program product being embodied in a non-transitory computer readable storage medium and comprising computer instructions for:
displaying, by a terminal, a transition image, wherein a graphics buffer is used in connection with displaying the transition image;
invoking, by the terminal, a web engine to render page content; and
displaying, by the terminal, the page content;
wherein the graphics buffer is reused in connection with displaying the page content.
